(19) United States
(12) Patent Application Publication
(10) Pub. No.: US 2002/0184161 A1
(43) Pub. Date: Dec. 5, 2002

(54) System and method for network address based software authorization

(76) Inventor: Allen Chang, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/873,733

(22) Filed: Jun. 4, 2001

(51) Int. Cl. G06F 17/60

(52) U.S. Cl. 705/59

(57) ABSTRACT

A method and a system for using an internet protocol (IP) address of a user data processing system to obtain from a software vendor an authorization code for activating a software application. In one embodiment, a computer implemented method and system facilitates obtaining an authorization code from a vendor data processing system for activating a software application on a user data processing system. The method includes establishing a license database including a plurality of internet protocol addresses referencing user data processing systems on which the software application is licensed to execute. The vendor data processing system obtains the internet protocol address of the user data processing system. Where the internet protocol address is recorded in the license database, the vendor data processing system transmits the authorization code to the user data processing system. The authorization code activates the software application on the user data processing system.

### FIELD OF THE INVENTION

The present invention generally relates to authorizing installation of a computer software program, and more particularly to securing an authorization code, which authorizes software installation, from a remote data processing system.

### BACKGROUND

Most computer manufacturers today load operating and application software directly on a personal computer's hard drive before selling the computer package to an end user. Additional application software is available for purchase in compact disks from retailers over the Internet or at their “brick and mortar” locations. In an effort to control installation and access to the purchased software, software vendors implement authorization schemes that permit the purchased or license software to operate in selected data processing systems. In one example, software vendors utilize a software matching scheme that requires the user to match, during the software installation process, a serial number on the software packaging or on a software certificate with a corresponding serial number embedded in the compact disk (“CD”). This approach obligates the user to keep the packaging and the CD together for later re-installations, thereby discouraging the user from lending the CD for others to copy. This approach, however, is expensive for the good faith user that loses the software certificate and now has to buy a new copy of the software.

Some application software is available for a moderate fee over the Internet. Upon accessing the vendor's website, a user selects a software application and provides a credit card number to effect payment. Once the payment is verified on-line, the software vendor authorizes access to the user by facilitating software downloading to the user's DPS. This approach is not practical for the user where the installation and authorization process of the application software is complex or will take too long over a 56K modem connection or over a digital subscriber line (DSL). In addition, changes in computer hardware by the user complicate later software installation due to the lack of readily available media from which to restore the software.

In another approach, the vendor authorizes access to the user of the purchased software by requiring the user to contact the vendor to obtain an authorization code. In obtaining the authorization code, the user usually discloses identification information of the software user/licensee to help the vendor identify the computer in which the software is to be installed. Before issuing the authorization code, the vendor usually verifies that the user purchased the software and verifies the general location of the software's installation. Although this approach affords the software vendor a high level of control over use and distribution of the software, such an authorization procedure is not practical if the user must wait days to receive the authorization code before completing installation of the software.

A system and method that address the aforementioned problems, as well as other related problems, are therefore desirable.

### SUMMARY OF THE INVENTION

The present invention is directed to addressing the above and other needs in connection with using an internet protocol (IP) address of a user data processing system to automatically obtain an authorization code for activating a software application from a software vendor. With the present approach, the IP address can also be used to identify the scope of the user's software application license with respect to the user's other data processing systems. The present invention is exemplified in a number of implementations and applications, some of which are summarized below.

According to one aspect of the invention, computer implemented method and system facilitates obtaining an authorization code from a vendor data processing system for activating a software application on a user data processing system. The method includes establishing a license database including a plurality of internet protocol addresses referencing user data processing systems on which the software application is licensed to execute. The vendor data processing system obtains the internet protocol address from the user data processing system. Where the internet protocol address is recorded in the license database, the vendor data processing system transmits the authorization code to the user data processing system. The authorization code activates the software application on the user data processing system.

According to another aspect of the invention, a computer-implemented method and system facilitates obtaining an authorization code from a vendor data processing system for activating a software application on a user data processing system. The method includes establishing a license database including a plurality of internet protocol addresses referencing user data processing systems on which the software application is licensed to execute. A user initiates installation of the software application in the user data processing system. The vendor data processing system obtains the internet protocol address from the user data processing system. Where the internet protocol address is recorded in the license database, the vendor data processing system transmits the authorization code to the user data processing system. Where the internet protocol address is not recorded in the license database, the vendor data processing system requests a user of the user data processing system to transmit a receipt code. After receiving the receipt code, the vendor data processing system transmits the authorization code to the user data processing system.

The above summary of the present invention is not intended to describe each illustrated embodiment or every implementation of the present invention. The figures in the detailed description that follow more particularly exemplify these embodiments.

### BRIEF DESCRIPTION OF THE DRAWINGS

Various aspects and advantages of the invention will become apparent upon review of the following detailed description and upon reference to the drawings in which:

FIG. 1 is a block diagram of a software application authorization system configured in accordance with an example embodiment of the invention;

FIG. 2A is a flowchart illustrating an example process of purchasing software in accordance with an example embodiment of the invention; and

FIG. 2B is a flowchart illustrating an example process of obtaining an authorization code for accessing a software program in accordance with an example embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention are described in terms of using an internet protocol (IP) address to obtain an authorization code for activating a software application. In a related approach, a data processing system having an unlicensed software application is issued an authorization code under a user master license upon registration of the IP address corresponding to the data processing system. For purposes of this application, data processing systems (DPS) include, but are not limited to, personal computers, internet appliances, e-Service related entities and objects, servers, workstations, and portable digital devices, such as PDAs and mobile communication devices. Those skilled in the art will appreciate that the invention could be implemented in a variety of programming languages, computer platforms and communications systems.

In an example embodiment, assigning authorization codes to IP addresses of the data processing system users facilitates activating software applications. Such a method reduces the cycle time and the investment in customer service personnel normally required in issuing authorization codes to software users. As the user is installing the software application on his data processing system, the software application prompts the user to provide the authorization code necessary to complete the software installation process. The user accesses the software vendor's website and the vendor's data processing system (DPS) obtains the internet protocol (IP) address from the user's data processing system. In a related application, the user DPS transmits the IP address to the vendor's data processing system. In another example embodiment, the IP address is obtained automatically by vendor's DPS from the user's DPS upon the two data processing systems establishing a connection. The vendor's data processing system verifies with a software license database that the user's IP address has a paid-up software license. Upon license verification, the vendor sends the authorization code to the user's data processing system to complete software installation. Where the IP address is not recorded in the license database, the vendor prompts the user to provide a receipt code; after which the authorization code is sent to the user. In this example embodiment, the vendor issues the receipt code to the user when the user purchases the software because the user does not have the IP address of his data processing system readily available. The vendor records the receipt code with the user's name in a receipt code database for use in a subsequent license verification process.

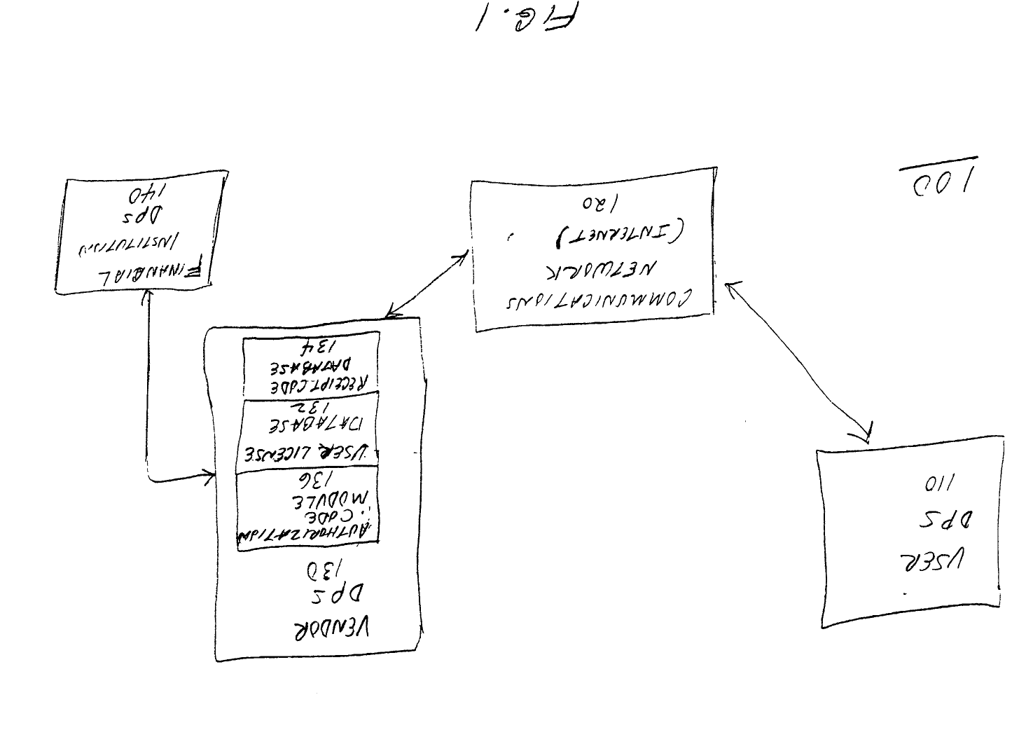

Referring now to the figures, FIG. 1 is a block diagram of a software application authorization system 100 configured in accordance with an example embodiment of the invention. In this example embodiment, a user who is installing a software application on a user data processing system (DPS) 110 is prompted by the software application to provide an authorization code. The user proceeds to obtain the authorization code from the software vendor by accessing a vendor's data processing system 130 via a conventional communications network 120. In this example embodiment, the communications network includes the Internet. In the example system 100, vendor DPS 130 includes a user license database 132, a receipt code database 134 and an authorization code module 136.

Once user DPS 110 connects with vendor DPS 130, vendor DPS 130 obtains the IP address from user DPS 110. Vendor DPS 130 uses the address to verify with user license database 132 if the user has paid for the software application. Upon license verification, authorization code module 136 sends an authorization code from vendor DPS 130 to user DPS 110 that corresponds to the transmitted address. In this example, the user completes software installation by entering the authorization code. In a related example embodiment, software installation automatically continues upon receipt of the authorization code by user DPS 110.

In a related embodiment, where an IP address is not found in database 132 verification of the paid software license is processed with a receipt code database 134. Where the user buys the software from the vendor at the physical retail location, the IP address may not be available for recording in license database 132. In this example, the vendor issues a receipt code to the user and records the receipt code in receipt code database 134. When the user seeks to obtain the authorization code on-line, the user receives the authorization code upon tendering the receipt code to the vendor.

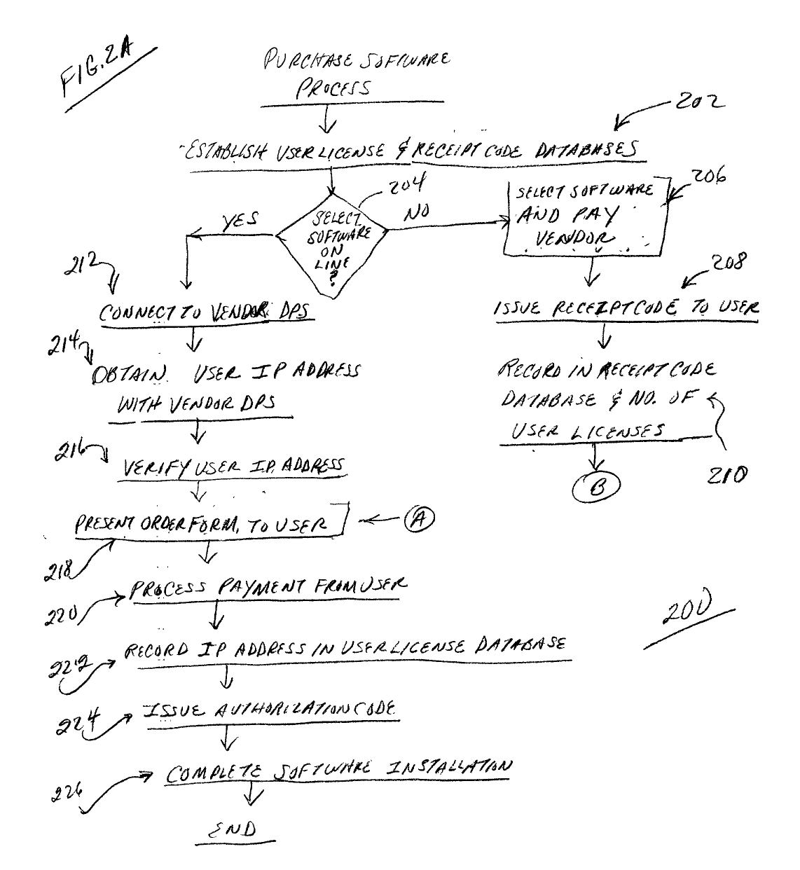

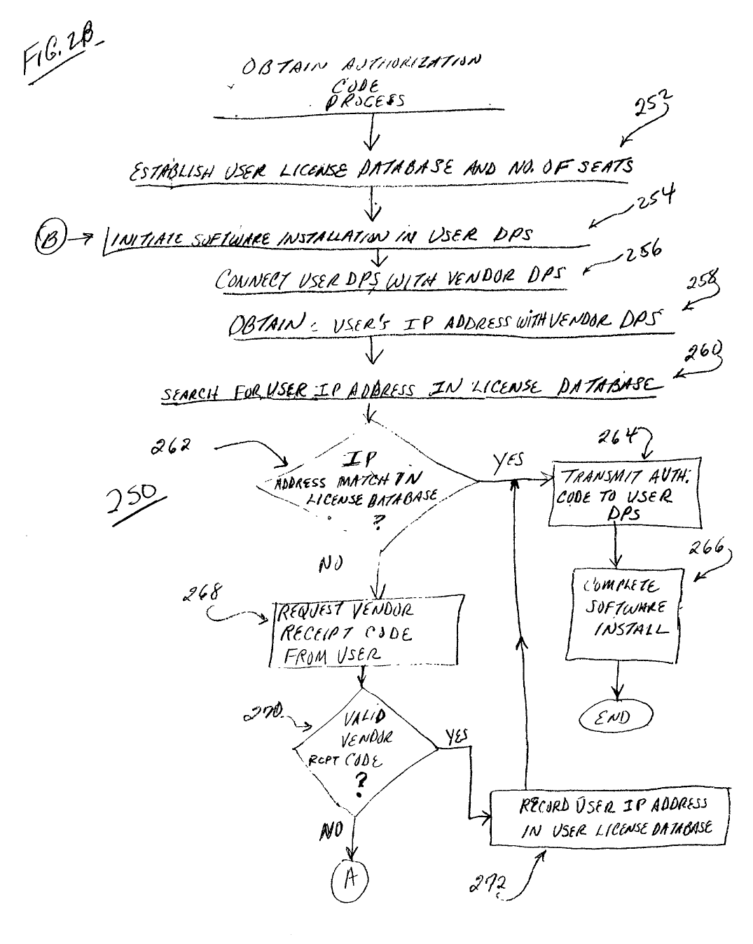

In another embodiment, software applications are purchased and activated during the same on-line session using the IP address of the user, as described above, and using a financial institution DPS 140 for payment verification. Financial DPS 140 includes a bank or credit card vendor that provides clearinghouse services (e.g., payment processing) for a vendor or a merchant via server that is located at the bank. In this example, the vendor creates a record in user license database 132 after the user purchases and downloads a selected software application from vendor DPS 130. The operation of system 100 will be described in more detail in connection with the discussion of FIG. 2.

Referring now to FIG. 2A, a flowchart 200 illustrates an example process of purchasing and activating a software application in accordance with an example embodiment of the invention. At step 202, the software vendor establishes user license database 132 and receipt code database 134 that indicates that a user has paid for at least one license for the software application. At step 204, a determination is made whether the user is selecting and purchasing the software application on-line with vendor DPS 130, via the Internet or via a dial-up system, or at the software retail location. In a related example, the user purchases the software application media on-line and initiates installation upon receipt of the software media (e.g., CDs). Where the user is not buying the software media on-line, but rather at the retailer, at step 206 the user selects the software application and pays vendor/retailer. Payment is verified via financial DPS 140 if the payment is made with a credit or charge card. At step 208, upon payment verification the retailer issues a receipt code that evidences that the user paid for the software application. With the receipt code, at step 210 the software vendor records the new receipt code in receipt code database 134 that indicates that a new user has paid for at least one license for the software application. Additional purchases of software licenses or “seats” by the particular user are also recorded at this time. At this point, the process proceeds to point B of FIG. 2B for installing and activating the software application.

In a related embodiment, the user and the software vendor set up an arrangement whereby the user pays for multiple software seats or “installations” under a single receipt code or a user master license. As each copy of the software is installed, the number of licensed copies is reduced. Each time the user seeks an authorization code, vendor DPS 130 verifies with receipt code database 134 whether the user has any licensed copies available. Where a license is available, vendor DPS 130 issues an authorization code to user DPS 110 and records the IP address in user license database 132. Upon exhausting the number of licensed copies, the user is prompted by vendor DPS 130 to purchase additional licensed copies before issuing the authorization code. This approach enables the user to utilize the same software media to install the software on each data processing system and enables the software vendor to track the number of software application copies by user, IP address and authorization code. In a related embodiment, the user utilizes the same software media on a replacement data processing system, due to the previous system failing (i.e., disk drive crashes), and then follows the process of obtaining the authorization code.

At step 212, user DPS 110 connects with vendor DPS 130 to facilitate the on-line purchase and activation of the software application. At step 214, vendor DPS 130 obtains IP address from user DPS 110. At step 216, vendor DPS 130 verifies the identity of DPS 110 using the obtained IP address by requesting a user of DPS 110 to response to a vendor generated verification message. Once the IP address is verified, at step 218 the vendor presents an order form to the user for the selected software application. At step 220, financial DPS 140 processes the user's payment for the selected software application. Upon payment verification, at step 222 vendor DPS 130 records the user's IP address in user license database 132. At step 224, authorization code module 136 of vendor DPS 130 generates and sends to user DPS 110 the authorization code. At step 226, the user completes software installation with the authorization code.

Referring now to FIG. 2B, a flowchart 250 illustrates an example process of obtaining an authorization code for activating a software application on a user DPS in accordance with an example embodiment of the invention. At step 252, the vendor establishes receipt code database 134 and user license database 132 that associates IP addresses and software applications. In a related embodiment, database 132 includes a record of multiple software application identifiers associated with the number of licensed copies that the user still has available. In this particular example, the user possesses the software media and, at step 254, initiates installation of the software on user DPS 110. At step 256, user DPS 110 connects via network 120 (e.g., Internet) with vendor DPS 130. At step 258, vendor DPS 130 obtains IP address from user DPS 110. At step 260, vendor DPS 130 searches user license database 132 for the obtained IP address. At step 262, a query of license database 132 seeks a match with the obtained IP address. At step 264, a match is found in license database 132 for the IP address, upon which vendor DPS 130 generates and transmits the authorization code to user DPS 110. At step 226, the user completes software installation.

Where no match is found in database 132, at step 268, vendor DPS 130 requests a user of DPS 110 to transmit the receipt code that evidences purchase of the software application. At step 270, the receipt code is verified with receipt code database 134. After receiving a valid receipt code, at step 272, vendor DPS 130 records the user IP address in license database 132. At step 264, vendor DPS 130 transmits the authorization code to the user DPS 110 for completing installation of software application. Where no match is found in receipt code database 134 for the receipt code, the process proceeds to point A of FIG. 2A where the user is presented with an order form for purchasing the software application being installed. The process continues as described above until the user obtains the authorization code.

The present invention is believed to be available to users of personal computers, mobile telephone, PDAs, pagers and other digital communication devices, such as internet appliances and e-Service related entities and objects, which are capable of loading application software. The present invention has been found to be particularly useful in reducing the time, cost and effort that both the vendor and the user expend in obtaining authorization codes for activating software applications. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer implemented method of obtaining an authorization code from a vendor data processing system for activating a software application on a user data processing system, the method comprising:
establishing a license database including a plurality of internet protocol addresses referencing user data processing systems on which the software application is licensed to execute;
obtaining the internet protocol address of the user data processing system using the vendor data processing system; and
if the internet protocol address is recorded in the license database, then transmitting the authorization code from the vendor data processing system to the user data processing system and activating the application with the authorization code.

2. The method of claim 1, further comprising if the internet protocol address is not recorded in the license database, then requesting a user of the user data processing system to transmit a receipt code to the vendor data processing system, and transmitting the authorization code from the vendor data processing system to the user data processing system after receiving the receipt code.

3. The method of claim 1, further comprising presenting to the user data processing system options for entry of a receipt code or an order form for the software application if the internet protocol address is not recorded in the license database.

4. The method of claim 3, further comprising the step of processing a payment by the user for the software application in response to the presented order form.

5. The method of claim 1, wherein the step of establishing the license database includes:
identifying a number of available software application licenses corresponding to the user that are not referenced to a particular internet protocol address and user data processing system; and
if the internet protocol address is not recorded in the license database, then associating at least one of the available software application licenses with the internet protocol address and transmitting the authorization code from the vendor data processing system to the user data processing system.

6. The method of claim 3, further comprising after establishing the license database, establishing a receipt code database including a plurality of users each associated with at least one software application license and if the receipt code is recorded in the receipt code database, then transmitting the authorization code from the vendor data processing system to the user data processing system.

7. The method of claim 4, wherein the step of processing a payment includes accessing a financial institution data processing system for conducting a payment verification.

8. A system of obtaining an authorization code from a vendor data processing system for activating a software application on a user data processing system, the system comprising:
means for associating a plurality of internet protocol addresses with user data processing systems on which the software application is licensed to execute;
means for obtaining the internet protocol address from the user data processing system; and
means for transmitting the authorization code to the user data processing system for activating the application where the internet protocol address is recorded in the license database.

9. The system of claim 8, further comprising a financial institution data processing system adapted to process a user payment for the software application in response to a vendor generated order form.

10. A computer implemented method of obtaining an authorization code from a vendor data processing system for activating a software application on a user data processing system, the method comprising:
establishing a license database including a plurality of internet protocol addresses referencing user data processing systems on which the software application is licensed to execute;
initiating installation of the software application in the user data processing system;
obtaining the internet protocol address of the user data processing system using the vendor data processing system;
if the internet protocol address is recorded in the license database, then transmitting the authorization code from the vendor data processing system to the user data processing system; and
if the internet protocol address is not recorded in the license database, then requesting a user of the user data processing system to transmit a receipt code to the vendor data processing system and transmitting the authorization code from the vendor data processing system to the user data processing system after receiving the receipt code.

11. The method of claim 10, further comprising if the receipt code is not received, then presenting to the user data processing system for user authorization an order form for the software application.

12. The method of claim 11, further comprising the step of processing a payment by the user for the software application in response to the presented order form.

13. The method of claim 11, further comprising after receiving the authorization code completing installation of the software application.

14. The method of claim 11, wherein the step of establishing the license database includes:
identifying a number of available software application licenses corresponding to the user that are not referenced to a particular internet protocol address and user data processing system; and
if the internet protocol address is not recorded in the license database, then associating at least one of the available software application licenses with the internet protocol address and transmitting the authorization code from the vendor data processing system to the user data processing system.

15. The method of claim 14, further comprising after obtaining the internet protocol address from the user data processing system:
if the internet protocol address is not recorded, then prior to presenting the order form to the user, performing steps (a)-(c):
(a) determining availability of at least one software application license corresponding to the user;
(b) if at least one license is available, then automatically transmitting the authorization code to the user data processing system and recording the internet protocol address in the license database; and
(c) if at least one the license is not available, then presenting the order form for the software application to the user data processing system.

16. The method of claim 11, further comprising after establishing the license database, establishing a receipt code database including a plurality of users each associated with at least one software application license, and if the receipt code is recorded in the receipt code database, then transmitting the authorization code from the vendor data processing system to the user data processing system.

17. The method of claim 16, wherein the step of establishing the receipt code database includes:
identifying a number of available software application licenses corresponding to the user that are not referenced to a particular receipt code; and
if the receipt code is not recorded in the receipt code database, then associating at least one of the available software application licenses with the receipt code and transmitting the authorization code from the vendor data processing system to the user data processing system.

18. The method of claim 17, further comprising after transmitting the receipt code to the vendor data processing system:
if the receipt code is not recorded, then prior to presenting the order form to the user, performing steps (a)-(c):
(a) determining availability of at least one software application license corresponding to the user;
(b) if at least one license is available, then automatically transmitting the authorization code to the user data processing system and recording the internet protocol address in the license database and the receipt code in the receipt code database; and
(c) if at least one the license is not available, then presenting the order form for the software application to the user data processing system.

19. The method of claim 12, wherein the step of processing a payment includes accessing a financial institution data processing system for conducting a payment verification.

20. A computer implemented method of obtaining an authorization code from a vendor data processing system for activating a software application on a user data processing system, the method comprising:
establishing a license database including a plurality of internet protocol addresses and associated software application identifiers of software applications licensed to execute on user data processing systems referenced by the internet protocol addresses;
initiating installation of the software application in the user data processing system;
obtaining the internet protocol address of the user data processing system using the vendor data processing system;
if the internet protocol address is recorded in the license database, then transmitting the authorization code from the vendor data processing system to the user data processing system; and
if the internet protocol address is not recorded in the license database, then requesting the user to transmit a receipt code to the vendor data processing system and presenting the user with the authorization code after receiving the receipt code.
